(19) United States
(12) Patent Application Publication
(10) Pub. No.: US 2021/0069760 A1
(43) Pub. Date: Mar. 11, 2021

(54) Self-Cleaning System for a Collapsible Straw

(71) Applicant: Juka Innovations Corporation, Farmingdale, NY (US)

(72) Inventor: Solyman Najimi, Farmingdale, NY (US)

(21) Appl. No.: 16/568,081

(22) Filed: Sep. 11, 2019

(51) Int. Cl. B08B 9/04; B65D 85/08

(52) U.S. Cl. CPC B08B 9/04; A47G 21/18; B65D 85/08

(57) ABSTRACT

A self-cleaning system for a collapsible straw is an apparatus that houses and cleans a collapsible straw. The apparatus includes an elongated casing, a plurality of scrubbing rods, and, preferably, a collapsible straw. The elongated casing protects and positions both the plurality of scrubbing rods and the collapsible straw. The plurality of scrubbing rods secures the position of the collapsible straw within the elongated casing while scrubbing the interior of the collapsible straw. The collapsible straw allows a user to drink a beverage with a personal and reusable straw. Moreover, the collapsible straw preserves the compact nature of the apparatus while in a storage configuration within the elongated casing. The apparatus further includes a lid to fully enclose the collapsible straw within the elongated casing. The lid is preferably locked and unlocked with the elongated casing with a locking mechanism.

### FIELD OF THE INVENTION

The present invention generally relates to straws. More specifically, the present invention is a self-cleaning system for a collapsible straw.

### BACKGROUND OF THE INVENTION

Straws are a common drinking tool typically used in many situations and environments. Whether in a fancy restaurant or in a casual outdoor setting, straws are typically sought for while drinking a variety of beverages. However, due to the rapid increase in plastic usage and damage to the environment, straws are a major contributor to plastic waste. Paper straws appear to be the next best option. However, paper straws still require recycled materials that may be used elsewhere and are single use only.

It is therefore an objective of the present invention to provide a multi-use and hygienic straw that is easily accessible within any setting. The present invention provides a compact and easily transportable straw that an individual may use at any point he or she desires. In between uses, the present invention preserves the hygiene of a collapsible straw and provides a holder that may be regularly cleaned as well.

### BRIEF DESCRIPTION OF THE DRAWINGS

FIG. 1 is a perspective view of the present invention with an elongated casing and a lid in an open configuration.

FIG. 2 is a perspective view of the present invention with the elongated casing and the lid in a closed configuration.

FIG. 3 is a right-side view of the present invention with the elongated casing and the lid in the closed configuration.

FIG. 4 is a cross-section view of FIG. 3 along line 4-4 of the present invention.

FIG. 5 is a magnified view a lengthwise piece of a collapsible straw engaged with a scrubbing rod of a plurality of scrubbing rods within the elongated casing of the present invention.

FIG. 6 is a top exploded view of the collapsible straw of present invention while in a deployed configuration.

FIG. 7 is a bottom exploded view of the collapsible straw of present invention while in the deployed configuration.

### DETAIL DESCRIPTIONS OF THE INVENTION

All illustrations of the drawings are for the purpose of describing selected versions of the present invention and are not intended to limit the scope of the present invention.

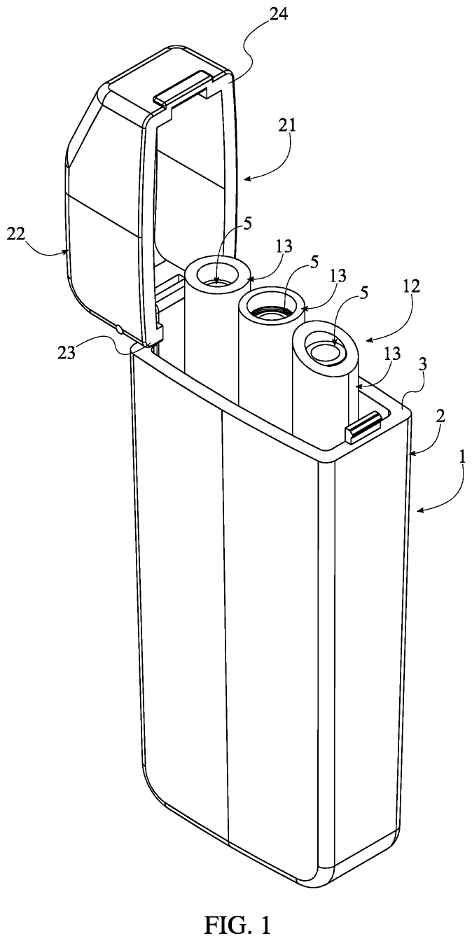

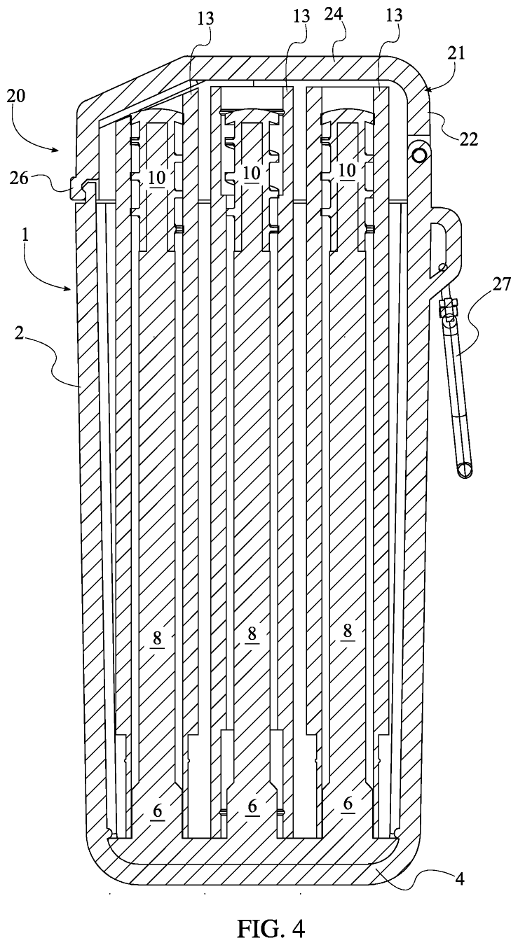

The present invention is a self-cleaning system for a collapsible straw that is hygienic and easily transportable. The present invention both cleans and stores a collapsible straw. The present invention is compact throughout transportation as a collapsible straw may be separated and stored while not in use. In order for the present invention to house and scrub a collapsible straw, the present invention comprises an elongated casing 1 and a plurality of scrubbing rods 5, seen in FIG. 1 and FIG. 4. The elongated casing 1 houses and conceals the plurality of scrubbing rods 5, and consequently a collapsible straw 12. Furthermore, the elongated casing 1 protects the plurality of scrubbing rods 5 throughout transportation from being bent or damaged. Each of the plurality of scrubbing rods 5 are safely and securely positioned within the elongated casing 1 as the elongated casing 1 comprises a first lateral wall 2 and a first base wall 4. The first lateral wall 2 upholds and positions the plurality of scrubbing rods 5. The first base wall 4 surrounds the plurality of scrubbing rods 5. The plurality of scrubbing rods 5 scrubs the interior of a collapsible straw 12 while stored within the elongated casing 1. Moreover, the plurality of scrubbing rods 5 scrubs a collapsible straw while inserted into the elongated casing 1 and while removed from the elongated casing 1. In the preferred embodiment of the present invention, the elongated casing 1 comprises rigid, light-weight metal materials for a durable construction, and the plurality of scrubbing rods 5 comprises a flexible, rubber-like materials in order to effectively scrub each of the plurality of scrubbing rods 5.

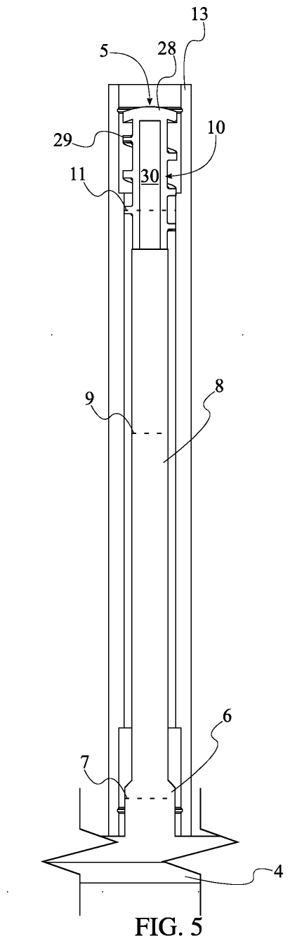

The overall configuration of the aforementioned components allows the present invention to protect a collapsible straw while maintaining hygiene, the first lateral wall 2 is positioned adjacent the first base wall 4, seen in FIG. 4 and FIG. 5. The plurality of scrubbing rods 5, and consequently a collapsible straw 12 may be positioned within the elongated casing 1, as the first lateral wall 2 is perimetrically fixed around the first base wall 4. More specifically, a rim 3 of the first lateral wall 2 is positioned opposite the first base wall 4 along the elongated casing 1. The rim 3 defines an opening for the elongated casing 1 that allows a collapsible straw 12 to be inserted into and removed from the elongated casing 1, seen in FIG. 1. The plurality of scrubbing rods 5 is positioned within the elongated casing 1 in order for the present invention to thoroughly clean a collapsible straw 12 while inserted into the elongated casing 1 and removed from the elongated casing 1. The collapsible straw 12 remains organized and easily accessible while positioned within the elongated casing 1 as the plurality of scrubbing rods 5 is fixed onto the first base wall 4 and is positioned parallel and offset from each other. More specifically, the plurality of scrubbing rods 5 traverses from the first base wall 4 to the rim 3 of the first lateral wall 2, ensuring the entire length of the collapsible straw 12 is scrubbed with the plurality of scrubbing rods 5.

The plurality of scrubbing rods 5 not only cleans a collapsible straw 12, but secures the position of the collapsible straw 12 within the elongated casing 1 as the plurality of scrubbing rods 5 each comprises a base portion 6, an extending portion 8, and a bristled portion 10, seen in FIG. 4. The base portion 6 prevents a collapsible straw 12 from slipping past the corresponding scrubbing rod and freely moving within the elongated casing 1. The extending portion 8 connects and offsets the bristled portion 10 from the base portion 6. The bristled portion 10 scrubs the interior of a collapsible straw 12 and captures any debris within a collapsible straw 12 while positioned within the elongated casing 1. The overall arrangement of each of the plurality of scrubbing rods 5, preserves the compact arrangement of the present invention as the base portion 6 is terminally positioned with the extending portion 8. Moreover, the bristled portion 10 is terminally positioned with the extending portion 8, opposite the base portion 6. A collapsible straw 12 is compactly stored within the elongated casing 1 as the base portion 6 is positioned adjacent the first base wall 4 and fixed with the first base wall 4. This arrangement ensures the entire length of a collapsible straw 12 is scrubbed while engaged with a scrubbing rod of the plurality of scrubbing rods 5. Moreover, in the preferred embodiment of the present invention, the bristled portion 10 is positioned adjacent the rim of the first lateral wall 4.

A collapsible straw 12 remains connected with a scrubbing rod of the plurality of scrubbing rods 5 unless purposefully removed by a user. In order the plurality of scrubbing rods 5 to secure the desired position of a collapsible straw 12 within the elongated casing 1, a diameter 7 of the base portion 6 is larger than a diameter 9 of the extending portion 8, seen in FIG. 5. The interior of a collapsible straw 12 is thoroughly cleaned as a diameter 11 of the bristled portion 10 is equal to the diameter 7 of the base portion 6. Moreover, the diameter 7 of the base portion 6, the diameter 9 of the extending portion 8, and the diameter 11 of the bristled portion 10 are positioned concentric with each other, allowing a collapsible straw 12 to continuously traverse along the corresponding scrubbing rod from the bristled portion 10 to the base portion 6.

In the preferred embodiment of the present invention, wherein a collapsible straw 12 is in a storage configuration, the collapsible straw 12 comprises a plurality of lengthwise pieces 13, seen in FIG. 1, FIG. 4, and FIG. 5. The plurality of lengthwise pieces 13 allows the collapsible straw 12 to be assembled and dissembled for proper use and compact storage. While in the storage configuration, the collapsible straw 12 is remains hygienic for multiple uses and is stored in an organized fashion. Each of the plurality of lengthwise pieces 13 is positioned around the extending portion 8 of a corresponding rod of the plurality of scrubbing rods 5, preserving the organization within the elongated casing 1. Furthermore, each of the plurality of lengthwise pieces 13 is frictionally engaged around the bristled portion 10 and the base portion 6 of the corresponding rod of the plurality of scrubbing rods 5. The friction with the bristled portion 10 allows the corresponding rod to scrub and remove any debris within the straw that may be adhered along the interior of the corresponding lengthwise piece of the plurality of lengthwise pieces 13. The friction between the base portion 6 secures the position of the corresponding lengthwise piece with the corresponding scrubbing rod of the plurality of scrubbing rods 5.

In order to preserve the structural integrity of the bristled portion 10 while frictionally engaging with the collapsible straw 12 and any debris within the collapsible straw 12, the bristled portion 10 comprises a seal head 28, a helical threading 29, and a shaft body 30, seen in FIG. 5. The seal head 28 reinforces position of the bristled portion 10 within the collapsible straw 12. The helical threading 29 scrubs the interior of the collapsible straw 12. The shaft body 30 securely connects bristled portion 10 with the extending portion 8. The helical threading 29 and the seal head 28 are positioned with the corresponding rod of the plurality of scrubbing rods 5 as the extending portion 8 is terminally fixed to the shaft body 30. Moreover, the seal head 28 is terminally fixed to the shaft body 30, opposite the extending portion 8. The helical threading 29 scrubs the interior of the collapsible straw 12 as the helical threading 29 is laterally fixed around the shaft body 30. Furthermore, the bristled portion 10 preserves the structural integrity of the collapsible straw 12 while scrubbing the collapsible straw 12, as the seal head 28 and the helical threading 29 are made of flexible rubber material.

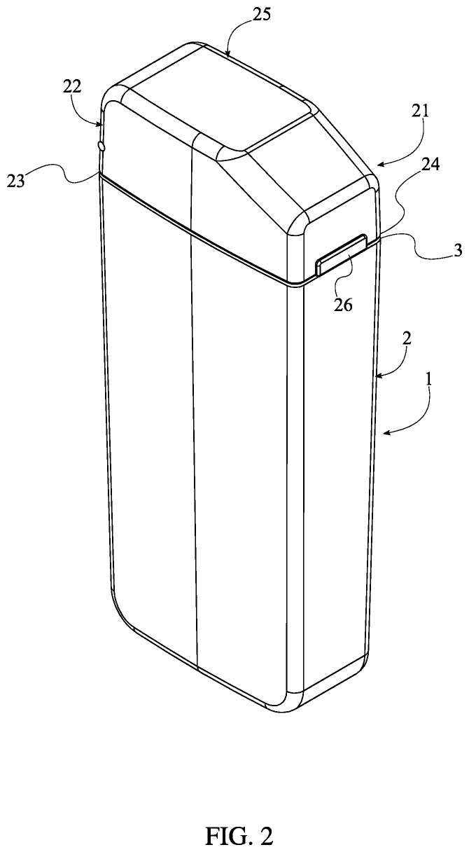

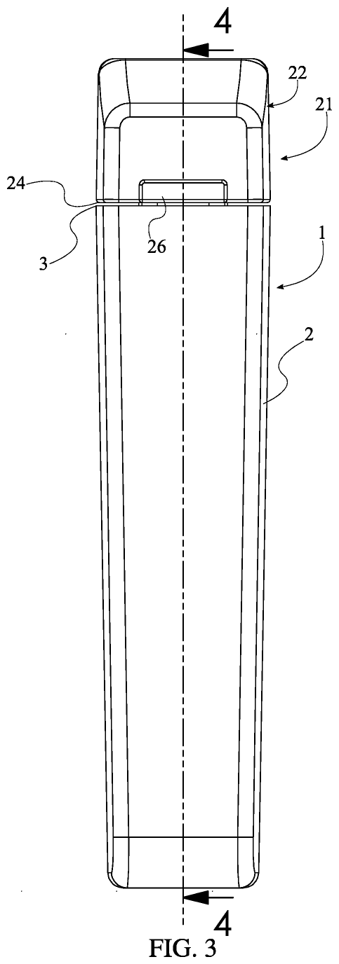

The present invention further comprises a lid 21 in order to enclose the collapsible straw 12 within the elongated casing 1, seen in FIG. 1, FIG. 2, FIG. 3, and FIG. 4. The lid 21 comprises a second lateral wall 22 and a second base wall 25 so that collapsible straws of various lengths may be engaged with the plurality of scrubbing rods 5. The second lateral wall 22 offsets the second base wall 25 from the elongated casing 1. The second base wall 25 covers the opening of the elongated casing 1. In order for the collapsible straw 12 to extend past the rim 3 of the first lateral wall 2, the second lateral wall 22 is positioned adjacent the second base wall 25 and is perimetrically fixed around the second base wall 25. In the preferred embodiment of the present invention, the plurality of scrubbing rods 5 traverses through the elongated casing 1 and into the lid 21 in order to scrub the entire length of the collapsible straw 12.

The lid 21 is remains connected with the elongated casing 1 as the second lateral wall 22 is positioned adjacent the first lateral wall 2, and a fixed edge 23 of the second lateral wall 22 is hingedly connected with the rim 3 of the first lateral wall 2, seen in FIG. 1. This arrangement allows the collapsible straw 12 and the interior of the elongated casing 1 to remain accessible and protected with the lid 21. Moreover, a free edge 24 of the second lateral wall 22 is positioned opposite the fixed edge 23 about the second lateral wall 22. The elongated casing 1 may be closed with the lid 21 as the present invention further comprises a locking mechanism 26. The locking mechanism 26 is preferably a couple of hooks that latch with each other while the elongated casing 1 is closed with the lid 21. The locking mechanism 26 allows a user to lock and unlock the lid 21 with the elongated casing 1. Moreover, the free edge 24 of the second wall is engaged with the rim 3 of the first lateral wall 2 by the locking mechanism 26.

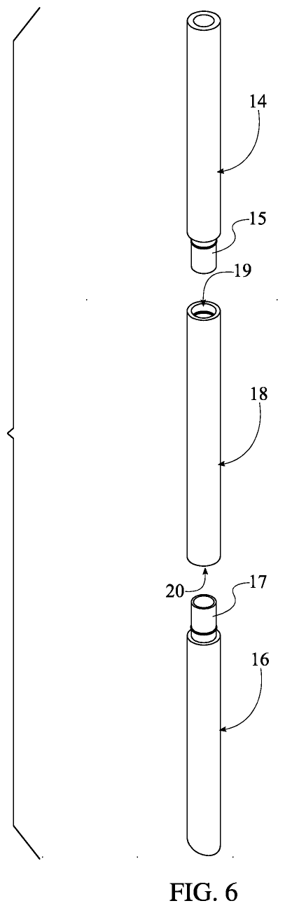

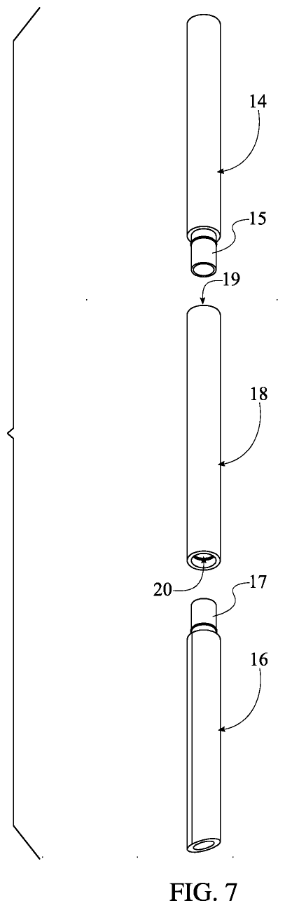

The collapsible straw 12 is ready for use with a beverage, while the collapsible straw 12 is in a deployed configuration, seen in FIG. 6 and FIG. 7. Wherein the collapsible straw 12 is in a deployed configuration, the collapsible straw 12 preferably comprises a proximal elongated piece 14, a distal elongated piece 16, and at least one intermediate elongated piece 18. The proximal elongated piece 14 delivers a beverage directly into the mouth of a user. The distal elongated piece 16 delivers a beverage from a drinking vessel such as a bottle or a glass to the proximal elongated piece 14 with the at least one intermediate elongated piece 18. The proximal elongated piece 14, the distal elongated piece 16, and the at least one intermediate elongated piece 18 allows a user to drink a beverage without coming into direct contact with the drinking vessel, limiting any spillage of the beverage. In order to define continuous and stable path for a beverage, the at least one intermediate elongated piece 18 is positioned in between the proximal elongated piece 14 and the distal elongated piece 16. More specifically, the proximal elongated piece 14, the at least one intermediate elongate piece, and the distal elongated piece 16 are serially positioned with each other. The proximal elongated piece 14 and the at least one intermediate elongated piece 18 remain connected with each other as a tapered end 15 of the proximal elongated piece 14 is frictionally engaged into a first open end 19 of the at least one intermediate elongated piece 18. Similarly, a tapered end 17 of the distal elongated piece 16 is frictionally engaged into a second open end 20 of the at least one intermediate elongated piece 18, securing the connection between the distal elongated piece 16 and the at least one intermediate elongated piece 18.

In the preferred embodiment of the present invention, the elongated casing 1 is attachable with a bag, a belt, and a variety of other compatible clothing and accessories. In order for the elongated casing 1 to be attached with clothing and accessories, the present invention preferably comprises a carabiner 27, seen in FIG. 4. The carabiner 27 is externally positioned with the elongated casing 1 and is coupled with the first lateral wall 2. This arrangement prevents the lid 21 from disconnecting with the elongated casing 1 while moving freely and throughout transportation. The elongated casing 1 preferably remains in an upright orientation throughout transportation as the carabiner 27 loop is positioned adjacent the rim 3 of the first lateral wall 2.

Although the invention has been explained in relation to its preferred embodiment, it is to be understood that many other possible modifications and variations can be made without departing from the spirit and scope of the invention as hereinafter claimed.

What is claimed is:

1. A self-cleaning system for a collapsible straw comprises:
an elongated casing;
a plurality of scrubbing rods;
the elongated casing comprises a first lateral wall and a first base wall;
the first lateral wall being positioned adjacent the first base wall;
the first lateral wall being perimetrically fixed around the first base wall;
a rim of the first lateral wall being positioned opposite the first base wall along the elongated casing;
the plurality of scrubbing rods being positioned within the elongated casing;
the plurality of scrubbing rods being fixed onto the first base wall;
the plurality of scrubbing rods being positioned parallel and offset from each other; and,
the plurality of scrubbing rods traversing from the first base wall to the rim of the first lateral wall.

2. The self-cleaning system for a collapsible straw as claimed in claim 1 comprises:
the plurality of scrubbing rods comprises a base portion, an extending portion, and a bristled portion;
the base portion being terminally positioned with the extending portion;
the bristled portion being terminally positioned with the extending portion, opposite the base portion;
the base portion being positioned adjacent the first base wall;
the base portion being fixed with the first base wall; and,
the bristled portion being positioned adjacent the rim of the first lateral wall.

3. The self-cleaning system for a collapsible straw as claimed in claim 2 comprises:
a diameter of the base portion being larger than a diameter of the extending portion;
a diameter of the bristled portion being equal to the diameter of the base portion; and,
the diameter of the base portion, the diameter of the extending portion, and the diameter of the bristled portion being positioned concentric with each other.

4. The self-cleaning collapsible straw and straw holder as claimed in claim 2 comprises:
wherein a collapsible straw is in a storage configuration;
the collapsible straw comprises a plurality of lengthwise pieces;
each of the plurality of lengthwise pieces being positioned around the extending portion of a corresponding rod from the plurality of scrubbing rods; and,
each of the plurality of lengthwise pieces being frictionally engaged around the bristled portion and the base portion of the corresponding rod.

5. The self-cleaning system for a collapsible straw as claimed in claim 2 comprises:
the bristled portion comprises a seal head, a helical threading, and a shaft body;
the extending portion being terminally fixed to the shaft body;
the seal head being terminally fixed to the shaft body, opposite the extending portion;
the helical threading being laterally fixed around the shaft body; and,
the seal head and the helical threading being made of a flexible rubber material.

6. The self-cleaning system for a collapsible straw as claimed in claim 1 comprises:
a lid;
the lid comprises a second lateral wall and a second base wall;
the second lateral wall being positioned adjacent the second base wall;
the second lateral wall being perimetrically fixed around the second base wall;
the second lateral wall being positioned adjacent the first lateral wall;
a fixed edge of the second lateral wall being hingedly connected with the rim of the first lateral wall; and,
a free edge of the second lateral wall being positioned opposite the fixed edge about the second lateral wall.

7. The self-cleaning system for a collapsible straw as claimed in claim 6 comprises:
a locking mechanism; and,
the free edge of the second wall being engaged with the rim of the first lateral wall by the locking mechanism.

8. The self-cleaning system for a collapsible straw as claimed in claim 6 comprises:
the plurality of scrubbing rods traversing through the elongated casing and into the lid.

9. The self-cleaning system for a collapsible straw as claimed in claim 1 comprises:
wherein a collapsible straw is in a deployed configuration;
the collapsible straw comprises a proximal elongated piece, a distal elongated piece, and at least one intermediate elongated piece;
the at least one intermediate elongated piece being positioned in between the proximal elongated piece and the distal elongated piece;
the proximal elongated piece, the at least one intermediate elongated piece, and the distal elongated piece being serially positioned with each other;
a tapered end of the proximal elongated piece being frictionally engaged into a first open end of the at least one intermediate elongated piece; and,
a tapered end of the distal elongated piece being frictionally engaged into a second open end of the at least one intermediate elongated piece.

10. The self-cleaning system for a collapsible straw as claimed in claim 1 comprises:
a carabiner;
the carabiner being externally positioned with the elongated casing;
the carabiner being coupled with the first lateral wall; and,
the carabiner loop being positioned adjacent the rim of the first lateral wall.

11. A self-cleaning system for a collapsible straw comprises:
an elongated casing;
a plurality of scrubbing rods;
a lid;
the elongated casing comprises a first lateral wall and a first base wall;
the first lateral wall being positioned adjacent the first base wall;
the first lateral wall being perimetrically fixed around the first base wall;
a rim of the first lateral wall being positioned opposite the first base wall along the elongated casing;
the plurality of scrubbing rods being positioned within the elongated casing;
the plurality of scrubbing rods being fixed onto the first base wall;
the plurality of scrubbing rods being positioned parallel and offset from each other; and,
the plurality of scrubbing rods traversing from the first base wall to the rim of the first lateral wall;
the lid comprises a second lateral wall and a second base wall;
the second lateral wall being positioned adjacent the second base wall;
the second lateral wall being perimetrically fixed around the second base wall;
the second lateral wall being positioned adjacent the first lateral wall;
a fixed edge of the second lateral wall being hingedly connected with the rim of the first lateral wall; and,
a free edge of the second lateral wall being positioned opposite the fixed edge about the second lateral wall.

12. The self-cleaning system for a collapsible straw as claimed in claim 11 comprises:
the plurality of scrubbing rods comprises a base portion, an extending portion, and a bristled portion;
the bristled portion comprises a seal head, a helical threading, and a shaft body;
the base portion being terminally positioned with the extending portion;
the bristled portion being terminally positioned with the extending portion, opposite the base portion;
the base portion being positioned adjacent the first base wall;
the base portion being fixed with the first base wall;
the bristled portion being positioned adjacent the rim of the first lateral wall;
the extending portion being terminally fixed to the shaft body;
the seal head being terminally fixed to the shaft body, opposite the extending portion;
the helical threading being laterally fixed around the shaft body;
the seal head and the helical threading being made of a flexible rubber material;
a diameter of the base portion being larger than a diameter of the extending portion;
a diameter of the bristled portion being equal to the diameter of the base portion; and,
the diameter of the base portion, the diameter of the extending portion, and the diameter of the bristled portion being positioned concentric with each other.

13. The self-cleaning collapsible straw and straw holder as claimed in claim 12 comprises:
wherein a collapsible straw is in a storage configuration;
the collapsible straw comprises a plurality of lengthwise pieces;
each of the plurality of lengthwise pieces being positioned around the extending portion of a corresponding rod from the plurality of scrubbing rods; and,
each of the plurality of lengthwise pieces being frictionally engaged around the bristled portion and the base portion of the corresponding rod.

14. The self-cleaning system for a collapsible straw as claimed in claim 11 comprises:
a locking mechanism;
the free edge of the second wall being engaged with the rim of the first lateral wall by the locking mechanism; and,

15. The self-cleaning system for a collapsible straw as claimed in claim 11 comprises:
the plurality of scrubbing rods traversing through the elongated casing and into the lid.

16. The self-cleaning system for a collapsible straw as claimed in claim 11 comprises:
wherein a collapsible straw is in a deployed configuration;
the collapsible straw comprises a proximal elongated piece, a distal elongated piece, and at least one intermediate elongated piece;
the at least one intermediate elongated piece being positioned in between the proximal elongated piece and the distal elongated piece;
the proximal elongated piece, the at least one intermediate elongated piece, and the distal elongated piece being serially positioned with each other;
a tapered end of the proximal elongated piece being frictionally engaged into a first open end of the at least one intermediate elongated piece; and,
a tapered end of the distal elongated piece being frictionally engaged into a second open end of the at least one intermediate elongated piece.

17. The self-cleaning system for a collapsible straw as claimed in claim 11 comprises:
a carabiner;
the carabiner being externally positioned with the elongated casing;
the carabiner being coupled with the first lateral wall; and,
the carabiner loop being positioned adjacent the rim of the first lateral wall.
